(19) United States
(12) Patent Application Publication
(10) Pub. No.: US 2015/0089633 A1
(43) Pub. Date: Mar. 26, 2015

(54) SYSTEM AND METHOD FOR ASSET ASSIGNMENT AND REPLACEMENT

(71) Applicant: Key Systems, Inc., Fishers, NY (US)

(72) Inventors: George H. Eckerdt, Victor, NY (US); Thomas Rockwell, Rochester, NY (US)

(21) Appl. No.: 14/323,256

(22) Filed: Jul. 3, 2014

Related U.S. Application Data
(60) Provisional application No. 61/842,908, filed on Jul. 3, 2013.

(51) Int. Cl. G06F 21/31; E05G 1/02; A47B 81/00

(52) U.S. Cl. CPC G06F 21/31; A47B 81/00; E05G 1/02
USPC 726/17; 312/237; 312/234

(57) ABSTRACT

A file cabinet drawer includes support rails supporting asset panels each with a plurality of asset positions to support respective assets and associated asset indicators. A controller activates panel, drawer, and asset indicators to locate assigned assets. A recipient can be reauthenticated and assigned a duplicate asset if the assigned asset becomes unavailable. An administrator can be authenticated to conduct assignment of duplicate assets. Where asset(s) include electronic identification tags, the panels can include contacts in electrical communication with support rails in respective drawers coupled to the controller to read an asset identifier from each tag.

### FIELD

The claimed invention generally relates to methods and systems for secure asset management. More particularly, the claimed invention relates to methods and systems for asset assignment and replacement.

### BACKGROUND

There is a need to store and track valuable assets, such as, but not limited to keys, identification cards, and passes. It is desirable to have a system and method to track and manage access to those assets, such that certain assets may be accountably assigned to a user in a streamlined, accountable fashion. Furthermore, it is also desirable to provide a reliable and efficient way to replace a previously assigned asset with a matching asset in the event that the previously assigned asset is lost.

### BRIEF DESCRIPTION OF THE DRAWINGS

FIGS. 1-4 illustrate different embodiments of a method for asset assignment.

FIGS. 5-6C schematically illustrate embodiments of a system for asset assignment.

FIG. 7 schematically illustrates another embodiment of a system for asset assignment.

FIG. 8 illustrates one embodiment of an initial asset storage for use in a system for asset assignment.

FIG. 9A illustrates one embodiment of an asset panel for use in a system for asset assignment.

FIG. 9B illustrates one embodiment of an asset having the identification tag from FIG. 9A for use in a system for asset assignment.

FIG. 10A illustrates a second embodiment of an asset panel for use in a system for asset assignment.

FIG. 10B illustrates one embodiment of an asset having an identification tag from FIG. 10A for use in a system for asset management.

FIG. 11A illustrates a third embodiment of an asset panel for use in a system for asset management.

FIG. 11B illustrates one embodiment of an asset having an identification tag from FIG. 11A for use in a system for asset management.

FIG. 12A illustrates a fourth embodiment of an asset panel for use in a system for asset management.

FIG. 12B illustrates one embodiment of an asset having an identification tag from FIG. 12A for use in a system for asset management.

FIG. 13A illustrates a fifth embodiment of an asset panel for use in a system for asset management.

FIG. 13B illustrates one embodiment of an asset having an identification tag from FIG. 13A for use in a system for asset management.

FIGS. 14A-14F illustrate one embodiment of a method for asset assignment using one embodiment of a system for asset management.

FIGS. 15A-1 to 15B illustrate one embodiment of a method for asset replacement.

FIG. 16 illustrates one embodiment of an asset panel having a plurality of coiled spring mounts for receiving a memory button.

FIG. 17 is a partially schematic plan view of a coil spring mount showing a gripped memory button in broken lines.

FIG. 18 is a partially cut-away and partially schematic view of a coil spring holder for a memory button attached to a key tag.

FIG. 19 is a side elevational view of the coil spring, memory button, and key tag of FIG. 18.

FIG. 20 is a side elevational view of the key tag of FIGS. 18 and 19.

FIG. 21 is a partially perspective view of a key hanging on a wire loop of the key tag of FIGS. 18, 19, and 20.

FIG. 22 is a side elevational view of the combination of a key, key tag, gripping spring, and circuit board to show how compactly a key can be mounted.

FIGS. 23-26 illustrate different embodiments of an asset panel for use with a system for asset management.

It will be appreciated that for purposes of clarity and where deemed appropriate, reference numerals have been repeated in the figures to indicate corresponding features, and that the various elements in the drawings have not necessarily been drawn to scale in order to better show the features.

### DETAILED DESCRIPTION

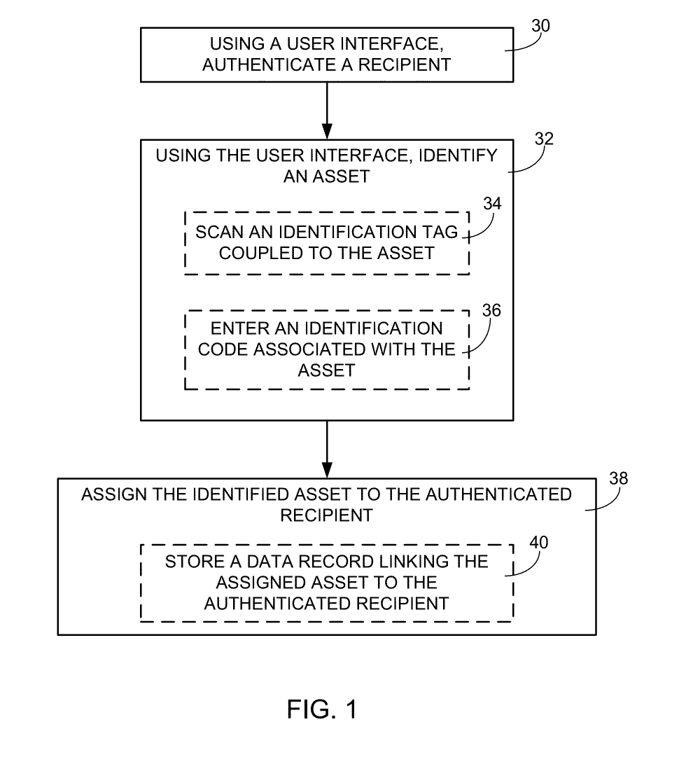

FIG. 1 illustrates one embodiment of a method of asset assignment. In step 30, a user interface is used to authenticate a recipient. The recipient can be someone to whom it is desired to assign an asset, such as, but not limited to a student who needs dormitory keys, a police officer who needs to be assigned keys to a cruiser, an office worker who needs filing cabinet keys, a lessee who needs apartment keys, or a worker who needs office keys. It should be understood that the asset is not limited to keys, however, keys are often used as examples throughout this specification for convenience. Examples of a suitable user interface for authenticating the recipient include, but are not limited to a keypad (for entering a personal identification number or other password or authentication information), a bar code scanner (for scanning one or more identification bar codes), a proximity card reader (for detecting one or more proximity cards having authentication information), a magnetic card reader (for detecting one or more magnetic cards having authentication information, a biometric device (for detecting one or more biometric identifiers), or any combination and/or plurality thereof. Suitable non-limiting examples of a biometric device may include a fingerprint reader, a hand shape reader, an iris pattern reader, and a retina scanner.

In step 32, the user interface is also used to identify an asset. If the asset has an identification tag which can be scanned, for example, but not limited to, by reading a bar code, a magnetic identification, a radio frequency identification (RFID) tag, or a proximity tag, then identifying the asset may comprise scanning 34 the identification tag coupled to the asset. As one alternative to scanning an identification tag, an identification code associated with the asset may be entered 36 to identify the asset.

In step 38, the identified asset is assigned to the authenticated recipient, and in step 40 a data record linking the assigned asset to the authenticated recipient is stored. This method, especially when used with an identification tag which can be scanned is a very efficient way to assign assets to a recipient while maintaining a record of the transaction. Non-limiting embodiments of suitable systems for implementing the methods described herein will be covered later in the specification.

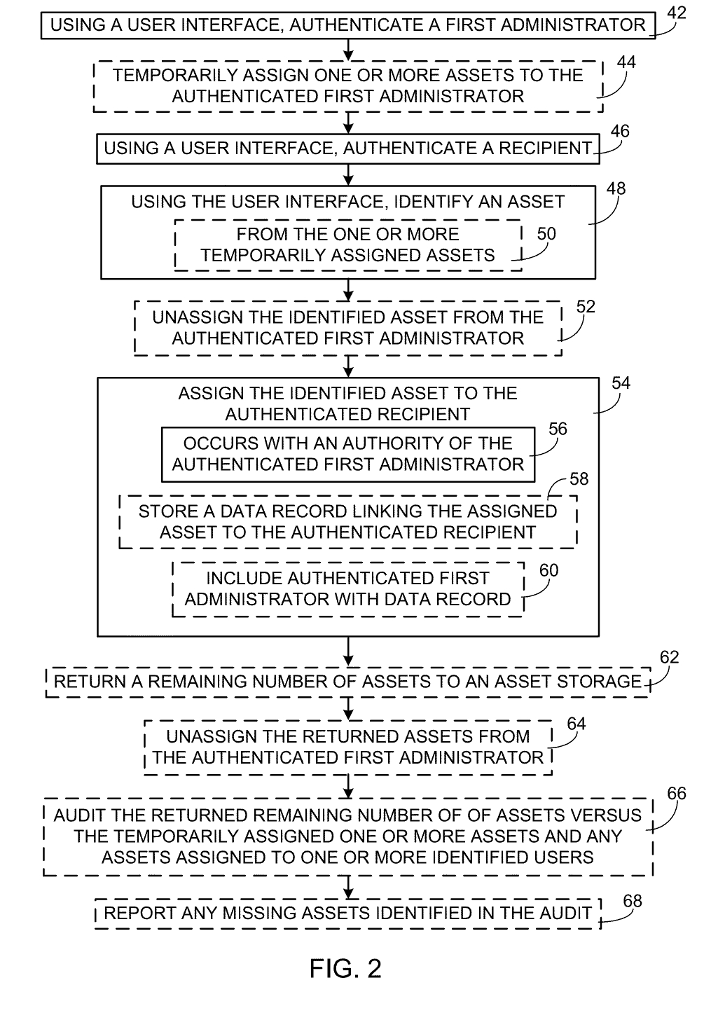

FIG. 2 illustrates a further method of asset assignment. Often times, when assets are being assigned, it may be useful to have someone in charge of the asset assignment process. In step 42, using a user interface, a first administrator is authenticated. Suitable embodiments of a user interface have been discussed above. This first administrator, who may be in charge of the asset assignment process, will sometimes be able to manage assignment of the assets directly from where they happen to be stored. Other times, it may be more practical for the administrator to move one or more of the assets to another location for distribution and assignment. For example, in the case where assets are keys at a college, a resident advisor (first administrator) may want to take a group of keys for his/her floor from a locked storage area to a table in a common room for distribution. Therefore, in optional step 44, one or more assets are temporarily assigned to the authenticated first administrator. In step 46, using the user interface, a recipient is authenticated, as has been discussed above. Using the user interface, the asset is identified in step 48 as has been discussed above. Optionally, the asset is identified 50 from the one or more temporarily assigned assets. In the case where the asset was one of the one or more temporarily assigned assets, the identified asset is unassigned from the authenticated first administrator in step 52.

In step 54, the identified asset is assigned to the authenticated recipient. Since an administrator is involved, this assignment 54 to the authenticated recipient occurs 56 with an authority of the authenticated first administrator. In such embodiments, the asset will not be properly assigned to the recipient without the first administrator being involved in the transaction, and the first administrator remains responsible for the assets temporarily assigned to him/her until they are properly assigned to a recipient or returned (as will be described shortly hereafter). In step 58, a data record linking the assigned asset to the authenticated recipient is stored, for example in a database, as has been discussed above. Optionally, a reference to the authenticated first administrator can be included 60 with the data record.

In step, 62, optionally, if the first administrator still has a remaining number of temporarily assigned assets assigned to them, the assets may be returned to an asset storage. In step 64, the returned assets may be unassigned from the authenticated first administrator. In optional step 66, the returned remaining number of assets are audited versus the temporarily assigned one or more assets and any assets assigned to one or more identified users. As such, it may be determined if any assets are unaccounted for, and in optional step 68, any missing assets identified in the audit may be reported. Reports may include, but are not limited to text message notifications, email notifications, web dashboard status updates, and visual, and/or audible alarms.

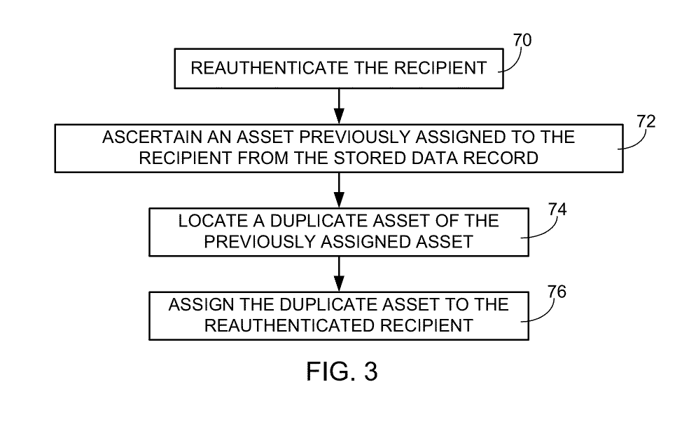

Once assets have been assigned to a recipient, it is often the case that a recipient may misplace the asset and require a replacement. FIG. 3 illustrates another embodiment of a method of asset assignment to address this situation. In step 70, the recipient is reauthenticated with a user interface. In step 72, an asset previously assigned to the recipient is ascertained from the stored data record. If multiple assets have been assigned to the recipient, then a secondary selection of the missing previously assigned asset may be performed. In step 74, a duplicate asset of the previously assigned asset is located. Again, non-limiting embodiments of suitable systems for implementing the methods described herein will be covered later in the specification. In step 76, the duplicate asset is reassigned to the reauthenticated recipient. This can include storing a new data record linking the assigned duplicate asset to the reauthenticated recipient.

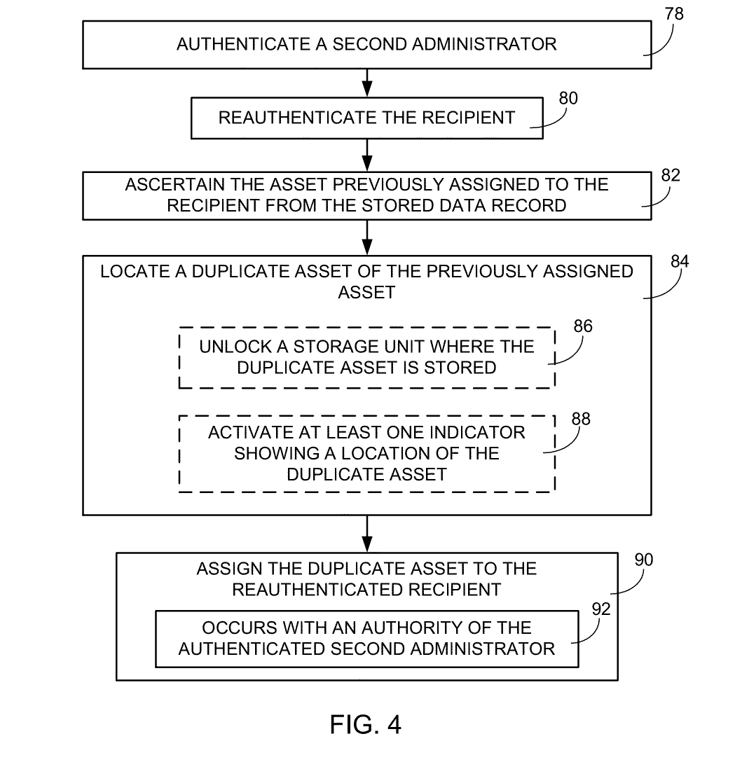

As with previous methods, it may be desirable to have an administrator be responsible for the asset replacement. FIG. 4 illustrates a further method of asset assignment. In step 78, a second administrator is authenticated with a user interface. It should be noted that in some cases, the person acting as administrator for this step may be the same person who authenticated as the first administrator or it may be a different person. In step 80, the recipient is reauthenticated with the user interface in a similar fashion to the original authentication. In step 82, the asset previously assigned to the recipient from the stored data record is ascertained as has been described above. In step 84, a duplicate asset of the previously assigned asset is located. As a non-limiting example, this may be done by electronically unlocking 86 a storage unit where the duplicate asset is stored, and/or activating 88 at least one indicator showing a location of the asset. The storage unit may include, but is not limited to, a file cabinet, a file cabinet drawer, and a locker. Examples of indicators may include, but are not limited to light emitting diodes (LEDs), incandescent lights, or even displays such as liquid crystal displays (LCDs) which can indicate the location of the asset. Some examples include lighting an LED on a file cabinet and/or a specific file cabinet drawer. Alternately, or additionally, an LED on a panel within a drawer could be lit to focus attention on the panel where the asset could be located, or even at a specific location on the asset panel (as will be discussed in more detail further in this patent application).

In step 90, the duplicate asset is assigned to the reauthenticated recipient. As with the assignments discussed above, this assignment 90, in this embodiment, occurs 92 with an authority of the authenticated second administrator.

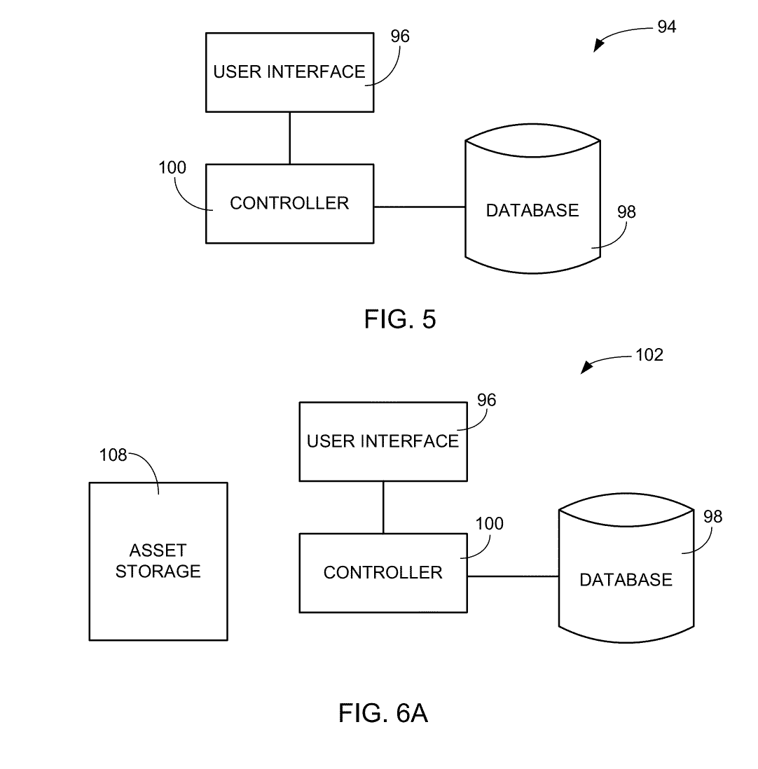

FIG. 5 schematically illustrates an embodiment of a system 94 for asset assignment. The system 94 has a user interface 96, a database 98, and a controller 100 coupled to the user interface 96 and the database 98. Examples of a suitable user interface 96 for authenticating the recipient include, but are not limited to a keypad, a bar code scanner, a proximity card reader, a magnetic card reader, a biometric device, or any combination and/or plurality thereof. Suitable non-limiting examples of a biometric device may include a fingerprint reader, a hand shape reader, an iris pattern reader, and a retinal scanner. The database 98 may be any type of machine readable memory or data storage where one or more data records may be stored. Non-limiting examples of a database 98 may include, a volatile memory, a non-volatile memory, randomly accessible memory (RAM), a magnetic storage media, an optical storage media, flash memory, phase change storage media, and any combination and/or plurality thereof, whether local or distributed.

The controller 100 is configured to authenticate a recipient via the user interface 96. As just a few examples, this could include authenticating a recipient by receiving and verifying an access code from a keypad of the user interface 96, receiving and verifying a magnetic code from a magnetic card reader of the user interface 96, or receiving and verifying a fingerprint from a fingerprint scanner of the user interface 96. Through the authentication process, the recipient provides some form of identification to the controller 100 via the user interface 96 that can be used to authenticate the recipient.

The controller 100 is further configured to identify an asset via the user interface 96. If the asset has an identification tag which can be scanned, for example, but not limited to, by reading a bar code, a magnetic identification, a radio frequency identification (RFID) tag, or a proximity tag, then identifying the asset may comprise scanning (with the user interface 96) the identification tag coupled to the asset. As one alternative to scanning an identification tag, an identification code associated with the asset may be entered via the user interface 96 to identify the asset. The asset identifier is thus provided to the controller 100 for identification of the asset.

The controller 100 is also configured to assign the identified asset to the authenticated recipient, for example by storing a data record in the database 98 linking the assigned asset to the authenticated recipient as has been discussed previously. The controller 100 may be a computer, a microprocessor, an application specific integrated circuit (ASIC), a field programmable gate array (FPGA), digital circuitry, analog circuitry, or any combination and/or plurality thereof, whether local or distributed.

The controller 100 may further be configured to authenticate a first administrator via the user interface 96, and the assignment of the identified asset to the authenticated recipient occurs with an authority of the authenticated first administrator. As mentioned previously, the stored data record linking the assigned asset to the authenticated recipient may also comprise a reference to the first administrator for purposes of an audit trail.

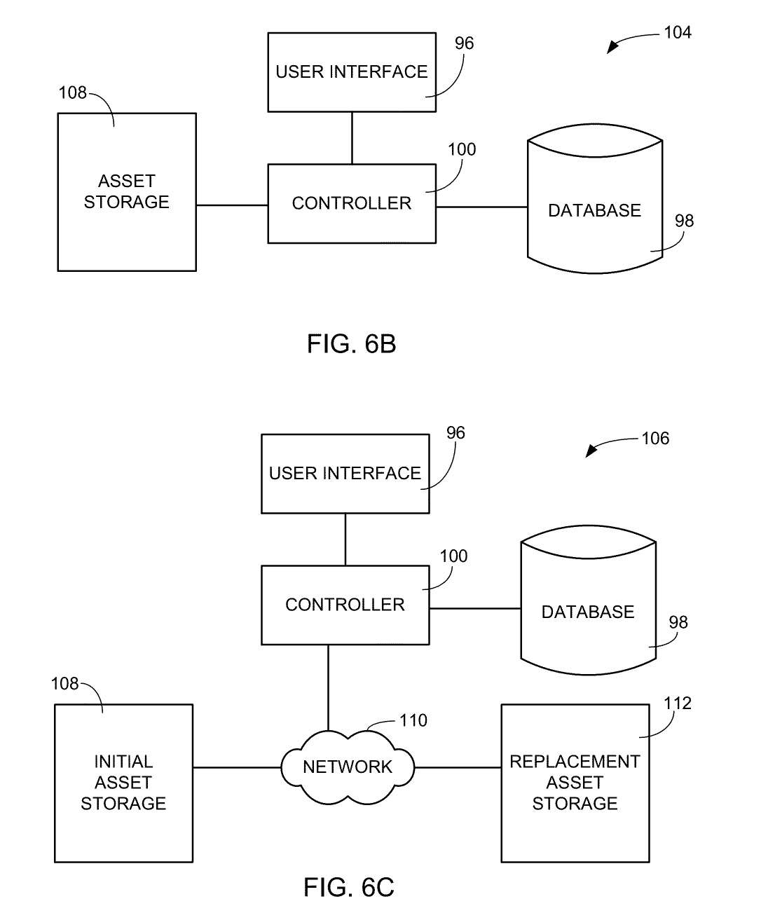

As shown in FIGS. 6A-6C, some embodiments of the system 102, 104, 106 may also have an initial asset storage 108. The initial asset storage 108 can house the assets while they are not assigned to anyone. In some embodiments, the initial asset storage 108 may be a secured storage lockable, for example with mechanical or electronic locks. The initial asset storage 108 may be decoupled from the controller 100 as shown in the embodiment of FIG. 6A. In other embodiments, the initial asset storage 108 may be coupled to the controller 100 as shown in the embodiment of FIGS. 6B and 6C. Embodiments where the initial asset storage 108 is coupled to the controller 100 have the potential advantage of being able to inform the controller 100 automatically when one or more assets are removed from the initial asset storage 108 by an authorized administrator. Such embodiments streamline the process of temporarily assigning one or more assets from the initial asset storage 108 to the first administrator as discussed above.

One way for the assets removed from the initial asset storage 108 to be temporarily assigned to the first administrator is for each asset to be tagged with an identifier which is monitored. In some embodiments, when the asset is removed from the initial asset storage 108, the system can recognize a disconnection from the monitored asset tag (for example in the case of a disconnection of a touch memory button from a Dallas semiconductor 1-Wire bus). The initial asset storage 108 may also be configured only to allow access to the assets after receiving an authentication from the first administrator. Thus, the system can know who accessed the initial asset storage 108 and which of the one or more assets were removed from the initial asset storage 108. Accordingly, the removed assets may automatically and temporarily be assigned to the administrator.

In other embodiments, the assets may be tagged with an identifier which can be scanned, but which is not monitored by the initial asset storage 108. The initial asset storage 108 may still be configured to allow access to the assets following an authentication from the administrator. The administrator could then remove assets, but would be responsible for scanning or entering the asset identifier into a user interface 96 in order to temporarily assign the assets to the administrator.

When the administrator is finished assigning one or more of the assets to others, if there are still one or more assets temporarily assigned to the administrator, then the system is configured to facilitate the return of the temporarily assigned assets. One way for the assets removed from the initial asset storage 108 to be returned is for each asset to be tagged with an identifier which is monitored. In some embodiments, when the asset is returned to the initial asset storage 108, the system can recognize a connection with the monitored asset tag (for example in the case of a connection of a touch memory button to a Dallas semiconductor 1-Wire bus). The initial asset storage 108 may also be configured only to allow access to the storage area after receiving an authentication from the first administrator. Thus, the system can know who accessed the initial asset storage 108 and which of the one or more assets were returned to the initial asset storage 108. Accordingly, the returned assets may automatically be unassigned from the administrator.

In other embodiments, the assets may be tagged with an identifier which can be scanned, but which is not monitored by the initial asset storage. The initial asset storage 108 may still be configured to allow return of the assets following an authentication from the administrator. The administrator could then return assets, but would be responsible for scanning or entering the asset identifier into a user interface 96 in order to unassign the assets from the administrator.

In the embodiment of FIG. 6B, the initial asset storage 108 is coupled directly to the controller 100. In the embodiment of FIG. 6C, the initial asset storage 108 is coupled to the controller 100 by a network 110. The network 110 may be, but is not limited to, a local area network (LAN), a wide area network (WAN), a wireless LAN, or a wireless WAN.

As illustrated in FIG. 6C, the system 106 may also include a replacement asset storage 112 configured to store duplicate assets of previously assigned assets. Although the replacement asset storage 112 is shown coupled to the controller 100 via a network 110 in this embodiment, it should be understood that the replacement asset storage 112 may be coupled to the controller in other ways, including a direct wired or wireless connection. In some embodiments, the duplicate assets may be tagged with an identifier which is monitored, for example, using a touch memory button on a 1-Wire communication bus (embodiments of which will be described in more detail later in this specification). As a result, the system can be configured to know the location of a particular duplicate asset and can activate an indicator to show the location of the duplicate asset within the replacement asset storage 112. While duplicate assets do not have to have tags which can communicate with the controller 100, such embodiments have the advantage that duplicate assets may be placed in any available location in the replacement asset storage 112, and the controller will know exactly where they are located in certain embodiments (to be discussed).

In a system having a replacement asset storage 112, such as the system 106 of FIG. 6C, the controller 100 may further be configured to reauthenticate the recipient via the user interface 96 as described previously. The controller 100 may also be configured to ascertain an asset previously assigned to the recipient from the stored data record. With a table showing what duplicate assets are located where, the controller 100 may also be configured to locate a duplicate asset of the previously assigned asset and assign the duplicate asset to the reauthenticated recipient. As before, logs may be kept of the transaction. The replacement asset storage 112 may be built into a variety of devices, including, but not limited to, a file cabinet, a file cabinet drawer, and a locker.

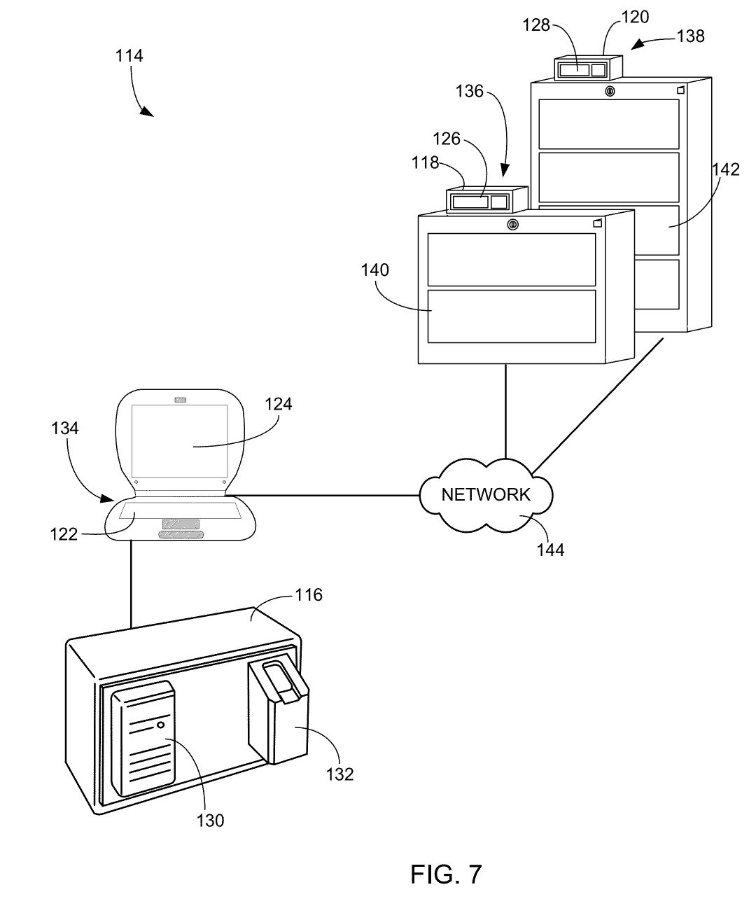

FIG. 7 schematically illustrates another embodiment of a system 114 for asset assignment. The system 114 has a user interface which is distributed among several devices, embodied here as a reader 116, keypads 118, 120, keyboard 122, and liquid crystal displays 124, 126, and 128. Other embodiments may have additional or fewer user interface options. In this embodiment, the reader 116 has two input devices, including a proximity card reader 130 and a fingerprint reader 132. The controller in this system is distributed among several locations, including in the laptop 134 and inside the control boxes 136, 138 attached to the file cabinets 140, 142, respectively. The file cabinets 140, 142 may be used for an initial asset storage and/or a replacement asset storage as discussed previously. The controllers communicate via a network 144. The controllers may be configured to operate independently of the other controllers and/or in conjunction with each other. The system 114 also has a database, as discussed previously, which can be stored in one or more memories coupled to any one or more of the controllers.

The controller (in this embodiment a distributed set of controllers) is configured to authenticate a recipient via the user interface (could be any of the one or more input devices), identify an asset via the user interface (for example by entering information via a keypad or by scanning a tag coupled to the asset), assign the identified asset to the authenticated recipient, and store a data record in the database linking the assigned asset to the authenticated recipient. The controller can also be configured to carry out the additional methods for asset assignment and asset replacement as discussed previously.

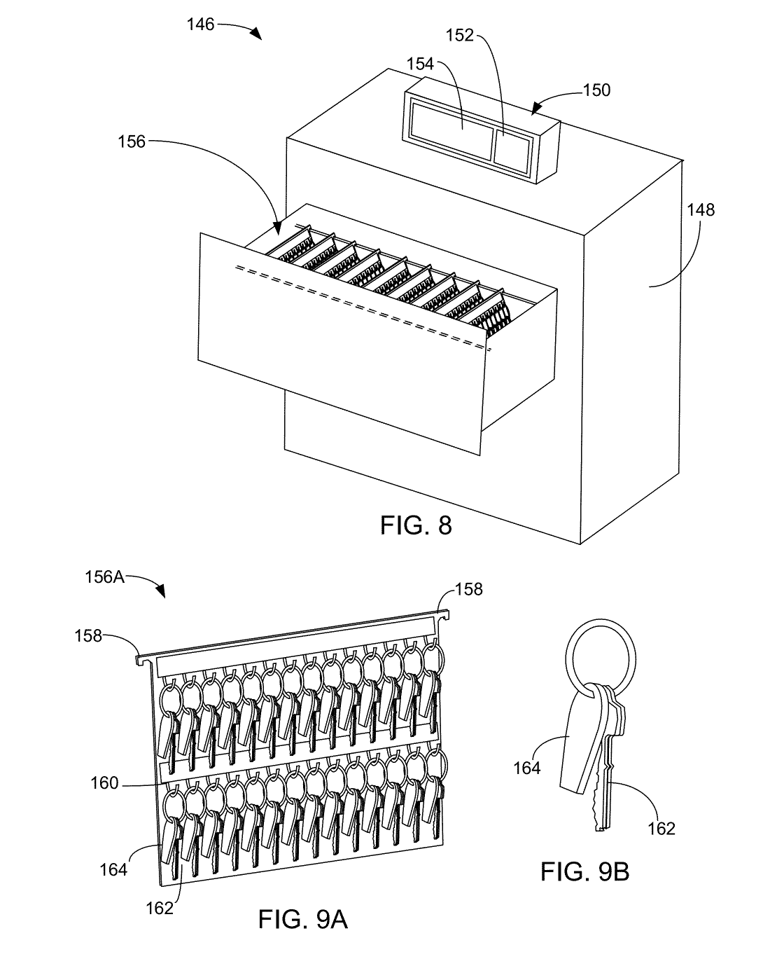

FIG. 8 illustrates one embodiment of an initial asset storage 146 for use in a system for asset assignment. In this embodiment, the initial asset storage 146 is made from a file cabinet 148 having a controller 150, a keypad 152, and an LCD screen 154. The file cabinet 148 may also be fitted with one or more electromechanical locks (not shown) which may be coupled to the controller 150 so that one or more file drawers may be selectively unlocked for authorized users upon proper authentication. Authentication may be determined via entry of a code at the keypad 152. Other embodiments may utilize one or more other or additional input devices, so, for example, authentication could be determined by the swiping of a magnetic pass card or a proximity badge. In this embodiment of an initial asset storage 146, a plurality of asset panels 156 are hung from the file cabinet rails. Each asset panel 156 may be configured to hold one or more assets (here shown as keys).

FIG. 9A illustrates one embodiment of an asset panel 156A for use in a system for asset assignment. In this embodiment, the asset panel 156A has hooks 158 configured to engage file folder rails in the file cabinet drawer, enabling the asset panel 156A to hang from the file folder rails like a hanging file folder. The asset panel 156A has multiple hooks 160 from which assets 162 (a key ring and key combination in this case) may be hung. FIG. 9B illustrates one embodiment of an asset 162 having an identification tag 164 coupled to it. In this embodiment, the identification tag 164 is a proximity tag having an identification that can be read by a proximity reader to identify the asset 162.

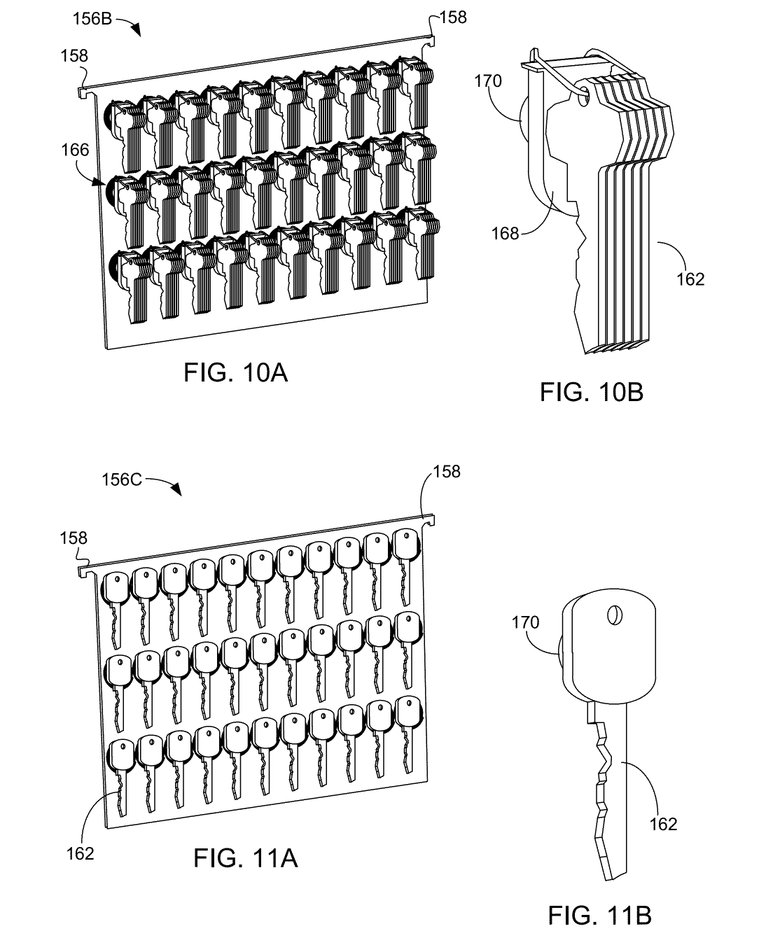

FIG. 10A illustrates another embodiment of an asset panel 156B for use in a system for asset assignment. In this embodiment, the asset panel 156B has hooks 158 configured to engage file folder rails in the file cabinet drawer, enabling the asset panel 156B to hang from the file folder rails like a hanging file folder. The asset panel 156B has multiple memory button mounts 166 (to be discussed in greater detail later) from which assets 162 coupled to a tag 168 having a memory button 170 may be attached. FIG. 10B illustrates one embodiment of the asset 162 having the tag 168 and memory button 170 coupled to it. In this embodiment, the memory button 170 has an identification number which can be electronically read by a controller coupled to the asset panel 156B. Therefore, the system may be configured to tell which assets (coupled to the memory buttons) are present and which assets have been removed. Asset removal/return information may be coupled with a user's name/identification as authenticated when opening the file cabinet drawer.

FIG. 11A illustrates another embodiment of an asset panel 156C for use in a system for asset assignment. In this embodiment, the asset panel 156C has hooks 158 configured to engage file folder rails in the file cabinet drawer, enabling the asset panel 156C to hang from the file folder rails like a hanging file folder. The asset panel 156C has multiple memory button mounts (not visible from this angle, but will be discussed in greater detail later) from which an asset 162 combined with a memory button 170 (not visible in FIG. 11A) may be attached. A suitable key combination with an electronic identifier (such as a memory button) is disclosed in U.S. patent application Ser. No. 13/589,472, which is hereby incorporated by reference in its entirety. FIG. 11B illustrates one embodiment of the asset 162 having the memory button 170 coupled to it. In this embodiment, the memory button 170 has an identification number which can be read by a controller coupled to the asset panel 156C. Therefore, the system may be configured to tell which assets (coupled to the memory buttons) are present and which assets have been removed. Asset removal/return information may be coupled with a user's name/identification as authenticated when opening the file cabinet drawer.

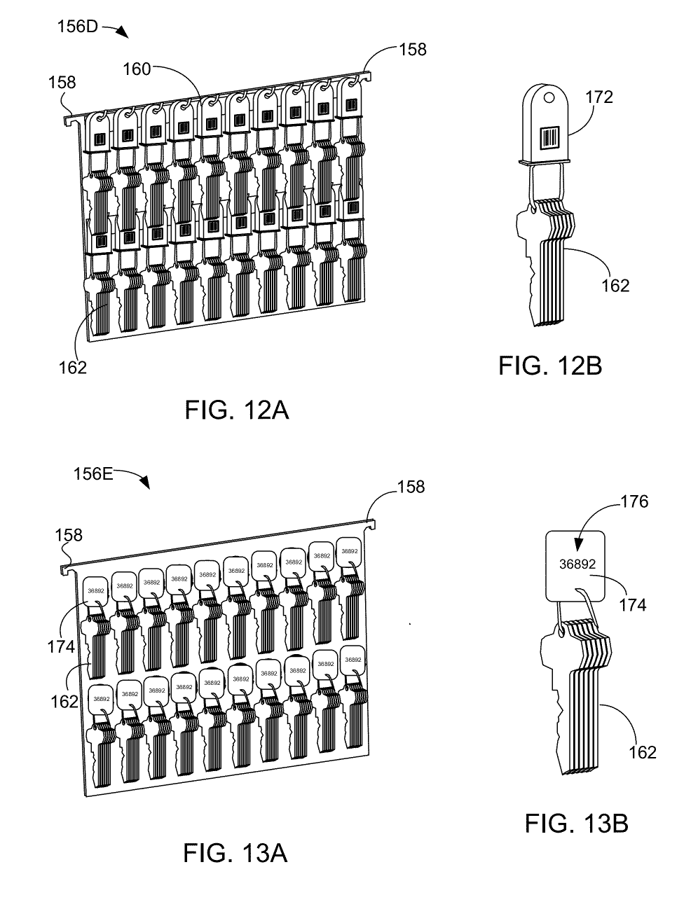

FIG. 12A illustrates one embodiment of an asset panel 156D for use in a system for asset assignment. In this embodiment, the asset panel 156D has hooks 158 configured to engage file folder rails in the file cabinet drawer, enabling the asset panel 156D to hang from the file folder rails like a hanging file folder. The asset panel 156D has multiple hooks 160 from which assets 162 (a key ring and key combination in this case) may be hung. As shown more clearly in FIG. 12B, the asset 162 may have an identification bar code 172 coupled to it. In this embodiment, the identification bar code 172 can be read by a bar code scanner to identify the asset 162.

FIG. 13A illustrates one embodiment of an asset panel 156E for use in a system for asset assignment. In this embodiment, the asset panel 156E has hooks 158 configured to engage file folder rails in the file cabinet drawer, enabling the asset panel 156E to hang from the file folder rails like a hanging file folder. The asset panel 156E may be covered in a velcro type loop material, and the assets 162 may be coupled to a tag 174 having a velcro type hook material (or visa versa) so that the assets 162 may be hung from the asset panel 156E. As shown more clearly in FIG. 13B, the asset 162 may have an identification code 176 coupled to it. In this embodiment, the identification code 176 can be entered by a user into a keypad or keyboard to identify the asset 162.

Although the embodiments for asset panels 156A-156E all were shown with file folder hooks 158, other embodiments may not utilize hooks to store the panels 156A-156E in the file cabinet or storage drawer. In other embodiments, panels could be stored on racks or otherwise stacked and stored together. In further embodiments, the panels could be integral with the inside of a drawer so that only the assets could be removed, rather than also having the option of removing an entire asset panel.

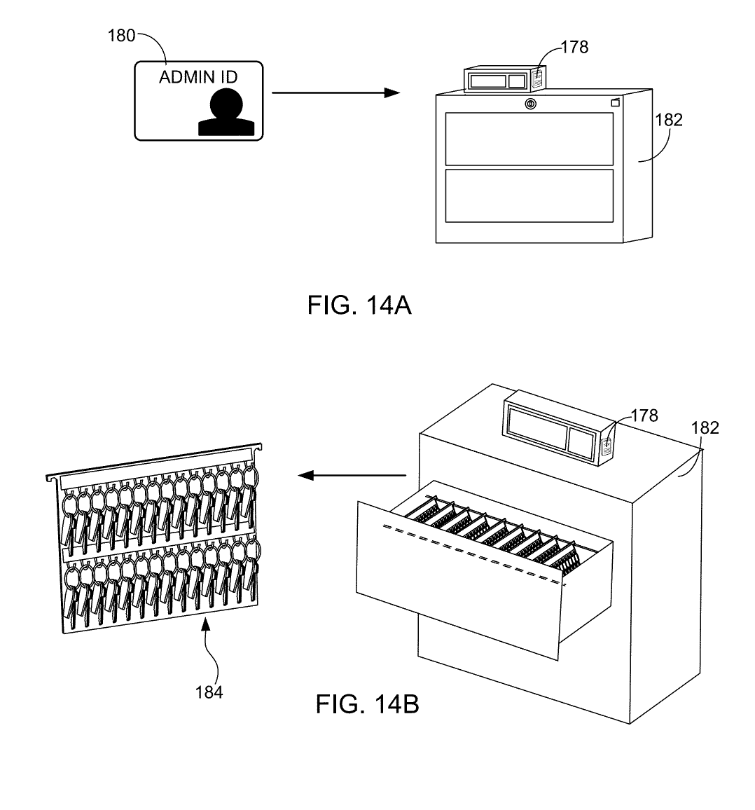

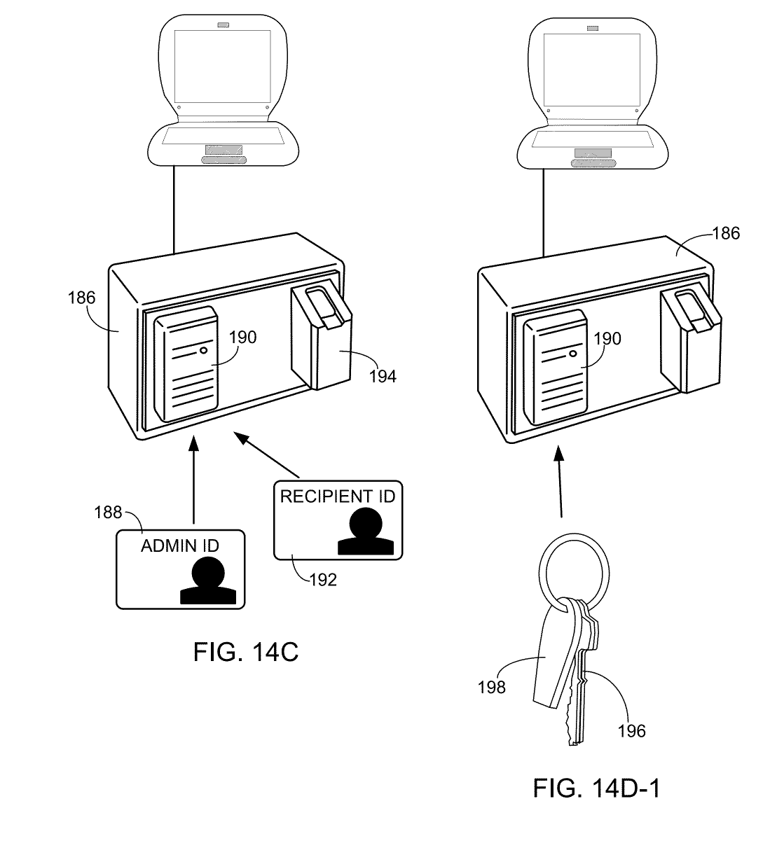

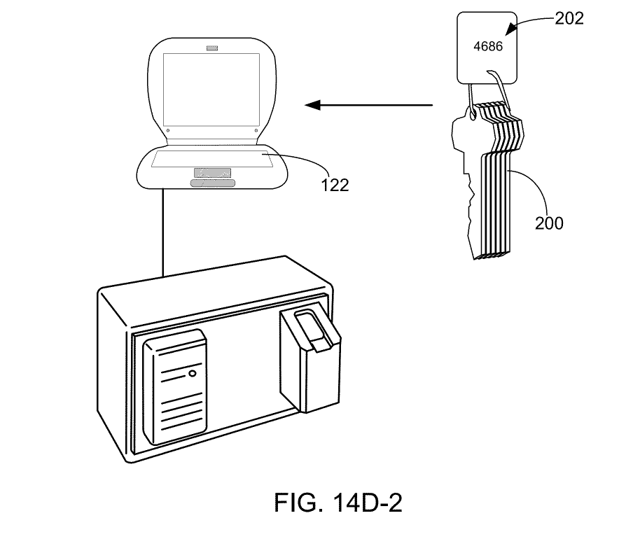

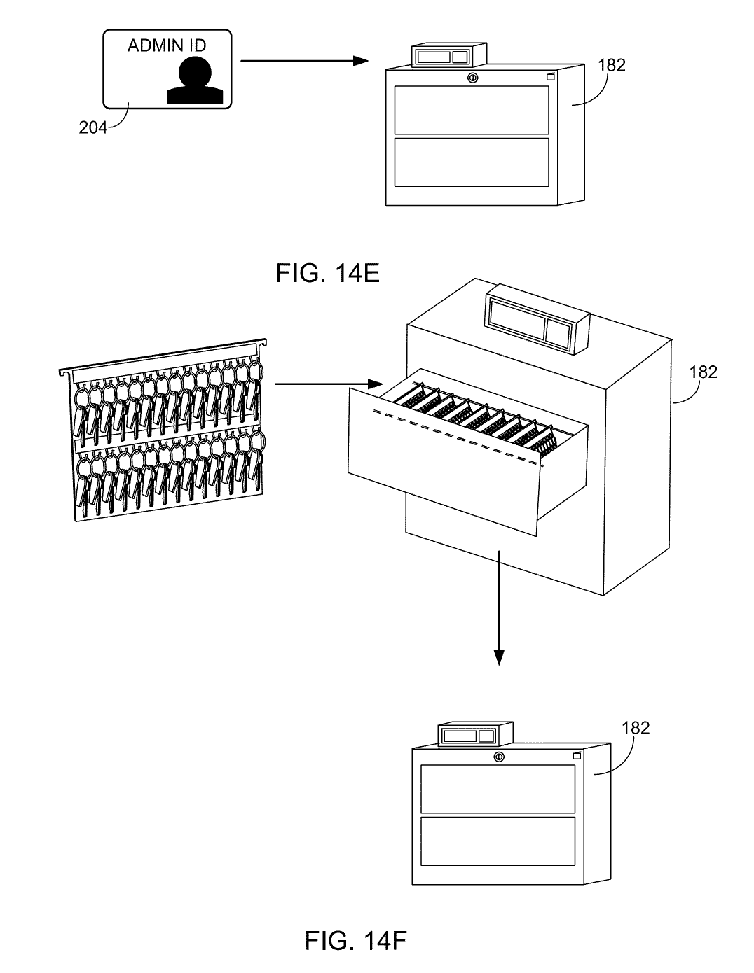

FIGS. 14A-14F illustrate one embodiment of a method for asset assignment using one embodiment of a system for asset management. As illustrated in FIG. 14A, using a user interface (here a card reader 178) a first administrator is authenticated by swiping an administrator identification card 180 by the card reader 178 coupled to an initial asset storage 182. As shown in FIG. 14B, the first administrator may then remove one or more assets from the asset storage 182. If the assets are coupled to a controller by an electronic identifier such as a touch memory button (such as, but not limited to the iButton from Dallas Semiconductor), then the system can automatically identify which assets were removed and can optionally be configured to temporarily assign the assets to the first administrator. Optionally, in other embodiments, the assets may have identification tags which may be scanned or entered into the system to identify which assets have been removed by the administrator. Some embodiments may not track which assets have been removed by the administrator, but there can at least be a record of who accessed the asset storage, if desired, when using authentication to gain access to the initial asset storage.

In the example here, an asset panel 184 is removed, the assets being sets of keys coupled to an RFID tag (proximity tag) by a key ring. Some initial enrollment and setup is recommended for the system so that known assets (keys in this example) are associated with known identification tags in the system database. For example, a key for a dormitory room number 520 in Finsbury Hall on the City University Campus can be pre-associated with a particular and unique identification tag.

One or more assets are now in the possession of the first administrator, and the administrator may wish to distribute the assets to one or more persons. As just one example, a resident advisor at a university may have a set of keys for the dormitory rooms on their floor in a campus residence. The resident advisor may wish to distribute the dorm room keys to students assigned to various rooms. The assets (in this example, keys) may be labeled to facilitate the administrator (here a resident advisor) handing the appropriate key to a student. However, it is desirable to track this transaction, so, as illustrated in FIG. 14C, the first administrator and the recipient each are authenticated via a user interface 186. In this example, the administrator is authenticated by placing a proximity ID 188 near a proximity reader 190. Similarly, a recipient is authenticated by placing their own proximity ID 192 near the proximity reader 190. Other embodiments may use other forms of identification for authentication, including, but not limited to using a fingerprint reader 194. In some embodiments, the administrator may not need to authenticate, and only the recipient will be authenticated. In still others, the administrator may only need to authenticate once for a session where several recipients will be then be authenticated. Authentication methods for administrators and recipients do not need to be the same, but can be.

As shown in FIG. 14D-1 an asset 196 may be identified via the user interface 186 by scanning an identification tag 198 coupled to the asset 196. In this example, the identification tag 198 is an RFID tag which can be read by the proximity reader 190 of the user interface 186. Since the association between the identification tag and the asset is known, the asset 196 may be assigned to the authenticated recipient (a relationship is created), and a data record linking the assigned asset to the authenticated recipient may be stored. Similarly (and alternately), as shown in FIG. 14D-2, an asset 200 may be identified via another portion of the user interface, here by entering an identification code 202 for the asset 200 into the system by keyboard 122.

When the administrator is finished handing out assets and assigning them to recipients, he/she may still have assets left over which were not assigned. The unassigned assets may be returned to the asset storage. As shown in FIG. 14E, it may be necessary for the administrator to identify themselves 204 to the storage 182 in order to gain entry. As shown in FIG. 14F, any remaining assets may be returned, and the asset storage 182 closed. If, in the process of returning the assets to the asset storage 182, the assets are recoupled to the controller by an electronic identifier such as a touch memory button (such as, but not limited to the iButton from Dallas Semiconductor), then the system can automatically identify which assets were returned and can optionally be configured to unassign the assets from the first administrator. Optionally, in other embodiments, the assets may have identification tags which can be scanned into the system to identify which assets have been returned by the administrator.

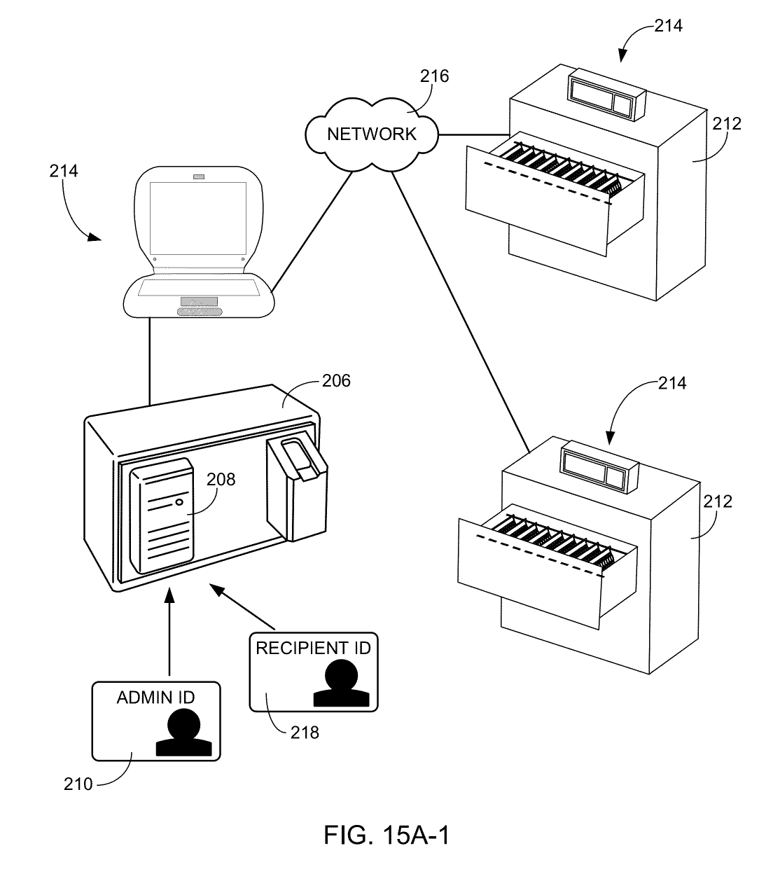

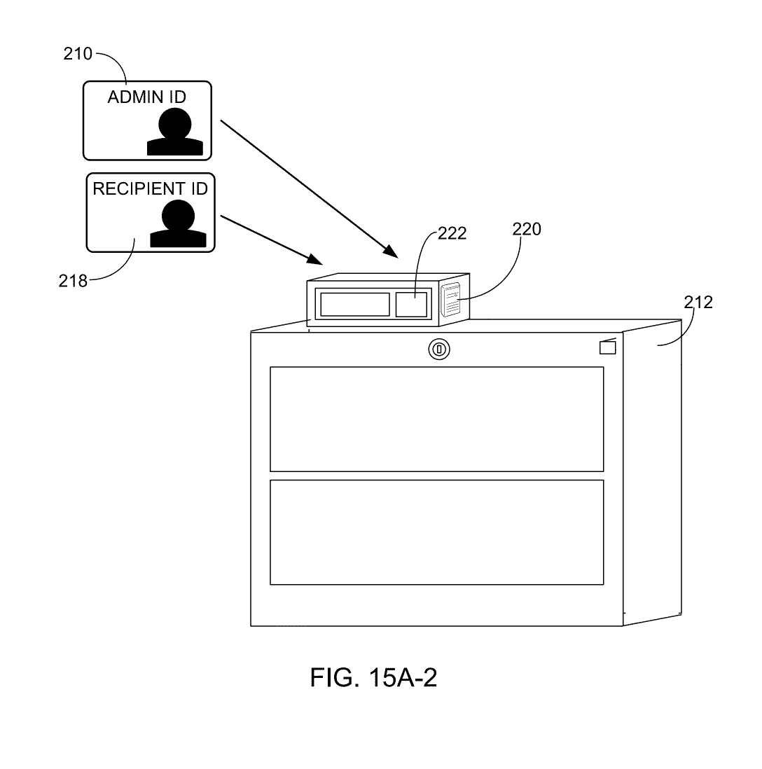

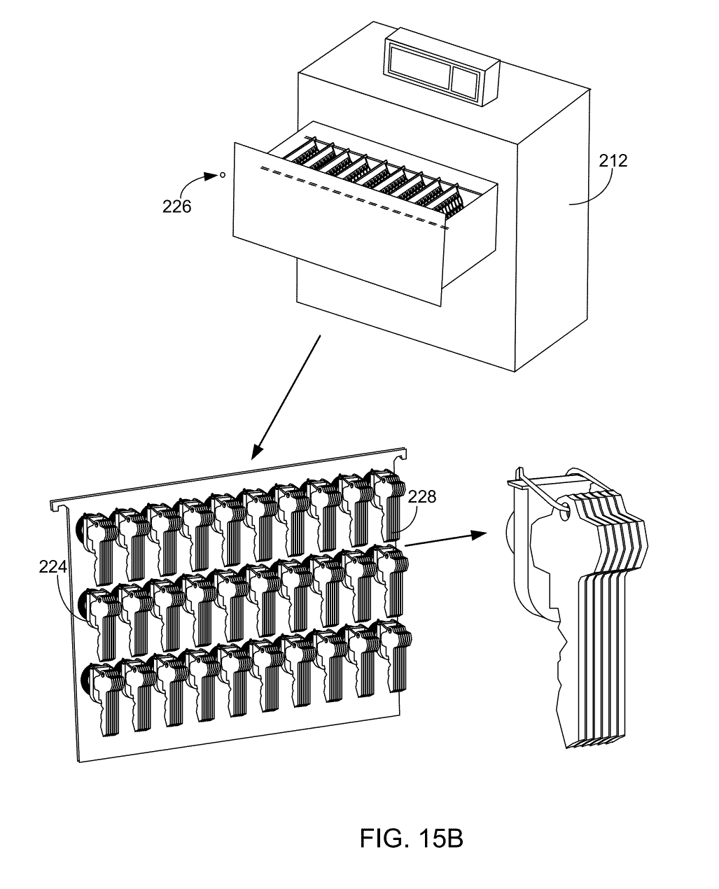

The systems and methods described herein, and their equivalents, provide a knowledge of which assets have been assigned to which recipients. This information can be used with further embodiments of the system to facilitate asset replacement in the event of a lost asset. FIGS. 15A-1 to 15B illustrate one embodiment of a method for asset replacement. As illustrated in FIG. 15A-1, using a user interface 206 (here, having a card reader 208) a second administrator is authenticated by swiping an administrator identification card 210 by the card reader 208 coupled to one or more replacement asset storages 212. In this example, the one or more replacement asset storages are coupled to the system by one or more distributed controllers 214 and a network 216. A recipient (in this case a person who has lost his/her asset or otherwise needs a replacement of the asset) is authenticated by swiping a recipient identification card 218 by the card reader 208. One or more of the controllers may ascertain what asset was previously assigned to the recipient. In the case where multiple assets have been assigned to the recipient, the recipient may need to provide additional input to the system so that the desired asset for replacement may be ascertained. One or more of the stored data records from the previous asset assignment may be used to ascertain the asset previously assigned to the recipient.

As illustrated in FIG. 15A-2, the method for asset replacement may alternately be initiated using a smaller type of system. For example, using a user interface, here a card reader 220 coupled to a replacement asset storage 212, a second administrator is authenticated by swiping an administrator identification card 210 by the card reader 220. A recipient (in this case a person who has lost his/her asset or otherwise needs a replacement of the asset) is authenticated by swiping a recipient identification card 218 by the card reader 220. A controller (not shown) may ascertain what asset was previously assigned to the recipient. In the case where multiple assets have been assigned to the recipient, the recipient may need to provide additional input to the system (for example, via keypad 222) so that the desired asset for replacement may be ascertained. One or more of the stored data records from the previous asset assignment may be used to ascertain the asset previously assigned to the recipient. The system shown in FIG. 15A-2 would need to be connected to a database of the previously assigned assets or have a copy of the database stored locally.

Since time has passed since the initial asset assignment, the administrator in the replacement process is referred to as a second administrator because it is possible that a different person is acting in an administrative capacity. However, it should be understood that the first administrator and the second administrator could be the same person in some scenarios.

The replacement asset storage may be configured to house replacement assets in an organized and preferably known fashion. For example, replacement keys (identical to those having been previously assigned) may be catalogued by drawer/asset panel location. Such a catalog of locations may be stored by the system for reference. In some embodiments, the replacement assets may have their own unique electronic identification tags that the system can query, such as a touch memory button. The system may be configured to take an inventory of the touch memory buttons, noting their position within the one or more replacement asset storage locations. An example of this process and a system for accomplishing it will be discussed later in more detail. In either type of scenario, after the asset previously assigned to the recipient is ascertained, the system can be configured to locate a duplicate asset of the previously assigned asset. The location of the replacement (duplicate) asset may be looked up in a database that was populated manually or automatically. In some embodiments, an indicator may be activated to help a user obtain the replacement asset that was located. As just a few examples: a) an LCD screen could display a file cabinet number, a file cabinet drawer, an asset panel number, and/or a specific location on an asset panel to help the user locate the replacement asset; b) a LED could be lit on a particular file cabinet, file cabinet drawer, an asset panel, and/or a specific location on an asset panel to help the user locate the replacement asset. In the example illustrated in FIG. 15B, the replacement asset storage 212 has the replacement assets stored on an asset panel 224 with memory buttons attached to each asset. An LED 226 on the file drawer and an LED 228 next to the replacement asset position can be activated by the controller during the location of the duplicate asset. The recipient can take the duplicate asset and the system can assign the duplicate asset to the recipient. Such a system and method can save administrators a lot of time and headache in locating replacement keys, especially in large settings such as within universities, apartment buildings, government buildings, and corporate buildings where there may be thousands of keys to manage and track.

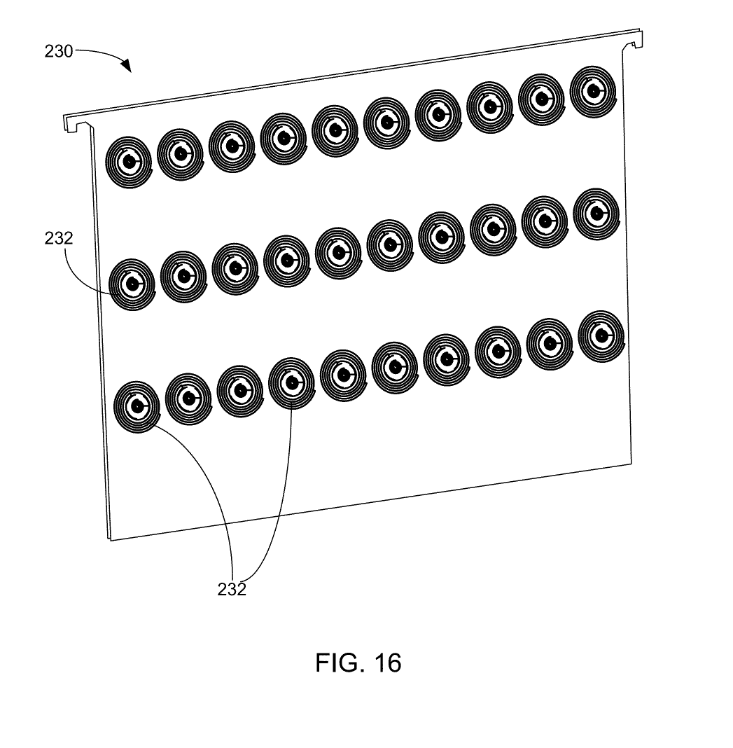

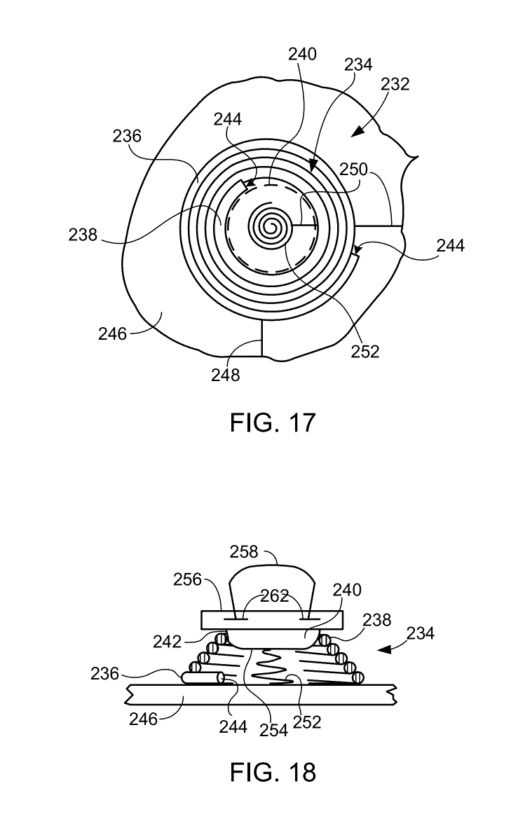

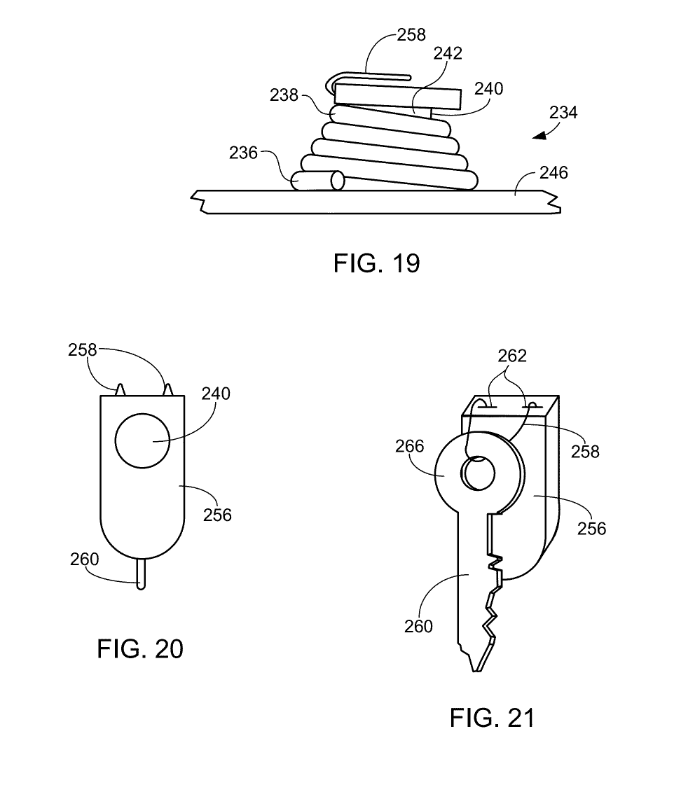

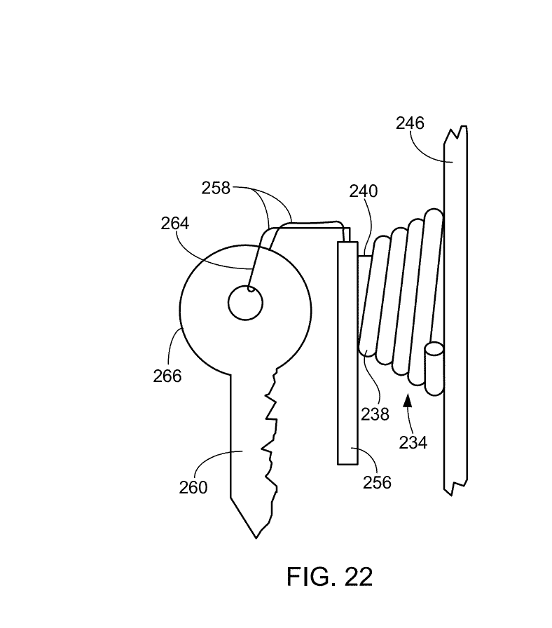

FIG. 16 illustrates one embodiment of an asset panel 230 having a plurality of coiled spring mounts 232 for receiving a memory button. Previous views of such an asset panel have had assets blocking the view of the memory button mounts, but embodiments of such mounts 232 will be discussed here in detail. The illustrated embodiments involve a coil spring gripper that releasably holds a memory button, and therefore an asset secured to the memory button. Such a configuration is especially suitable for keys as the objects to be secured, although it should be understood that this can be used for assets which are not keys. The memory button mount 232 is further illustrated in FIGS. 17-19 and an embodiment of a key tag is illustrated in FIGS. 18-22. Many variations are possible for mounting memory buttons directly on the heads of keys or on other assets to be secured.

This embodiment of a memory button mount 232 has a coil gripping spring 234. The coil gripping spring 234 preferably has a conical shape as illustrated, with a base coil 236 having a larger diameter than a gripping coil 238 arranged at a top of spring 234. Top coil 238 can then grip memory button 240 as illustrated in broken lines in FIG. 17. Spring 234 is preferably made of a conductive metal, such as music wire so that it electrically communicates with a cylindrical periphery 242 of memory button 240. It can be made in many configurations, including cylindrical, but the illustrated conical shape is preferred for stability.

The ends 244 of spring 234 can be cut off square, as shown in FIG. 17, or can be machined to tapers that more closely fit a plane surface. Experience has shown that this is not necessary, however. Even cut off square, as shown in FIG. 17, gripping coil 234 surrounds about ¼ or about 270 degrees of the cylindrical surface 242 of memory button 240. This affords a grip strong enough to releasably support both memory button 240 and tags or objects secured to memory button 240. The grip of spring 234 on memory button 240 is aided by the fact that memory button 240 does not need to be disposed parallel with a support surface 246 to which base coil 236 is secured. Spring 234, in the simple illustrated configuration, can be made on a fourslide machine, which is preferred for keeping the manufacturing expense low.

A support surface 246 is preferably a circuit board having established conductive paths 248 and 250. There are countless ways that electrically conductive paths can be designed on a circuit board 246 or other support to read identities from an array of memory buttons 240. They all require a single signal line, paired with a neutral line. Those of ordinary skill in the art are readily familiar with the 1-wire communication protocol from Dallas Semiconductor, for example, for their touch memory iButtons, and such a protocol can be used to communicate with the touch memory buttons in these embodiments and their equivalents.

A contact spring 252, of much lighter gauge than gripping spring 234, is preferably mounted on circuit board 246 within base coil 236 to extend up to a region within gripping coil 238 to electrically contact a plane face surface 254 of memory button 240. Contact spring 252 thus contacts an electrode of memory button 240 while gripping spring 234 contacts another electrode of memory button 240 so that identification numbers of memory button 240 can be accessed simply.

Spring 234, in addition to providing electrical contact with a cylindrical perimeter 242 of memory button 240, also grips and releasably holds memory button 240 by the frictional grip of upper coil 238. The springiness of the wire of spring 234 allows upper coil 238 to expand slightly when memory button 240 is pressed into place within the wrap of coil 238. This wrap extends around more than half of the cylindrical surface of memory button 240, and preferably about 270 degrees, to hold memory button 240 securely. Coils of spring 234 preferably contact each other in an unflexed state so that pushing button 240 into gripping coil 238 is resisted by the underlying coils to force gripping coil 238 to expand slightly in diameter to receive button 240. This assures a secure and reliable grip on button 240 that remains releasable for removing a secured object.

For security of keys, memory button 240 is preferably secured to a tag 256 that holds a wire 258 on which a key 260 can hang. Tag 256 has slits 262 at an upper end to receive barbed ends of wire 258. A key 260, mounted on wire 258 is secured to tag 256 once the barbed ends of wire 258 are inserted into slits 262 from which the wire cannot be extracted. Memory button 240 is secured to one face of tag 256, and wire 258 is bent to extend into a space on a side of tag 256 opposite button 240.

With circuit board 246 oriented vertically and coil spring 234 oriented horizontally, tag 256 can hang vertically from the grip afforded by memory button 240 in the gripping coil 238 of spring 234. This disposes hanging wire 258 near the top of tag 256 with a loop 264 disposed on a side of tag 256 opposite button 240 where the head 266 of key 260 is disposed above a bottom end 268 of tag 256. This is shown in FIGS. 20-22. This arrangement makes compact storage for an array of keys so that many more keys and tags can be mounted in a security box than if the tags were hung with the wire end downward. This would extend the hanging wire 258 below the bottom of tag 256, with key 260 extending even farther below tag 256 where it would require much more hanging space.

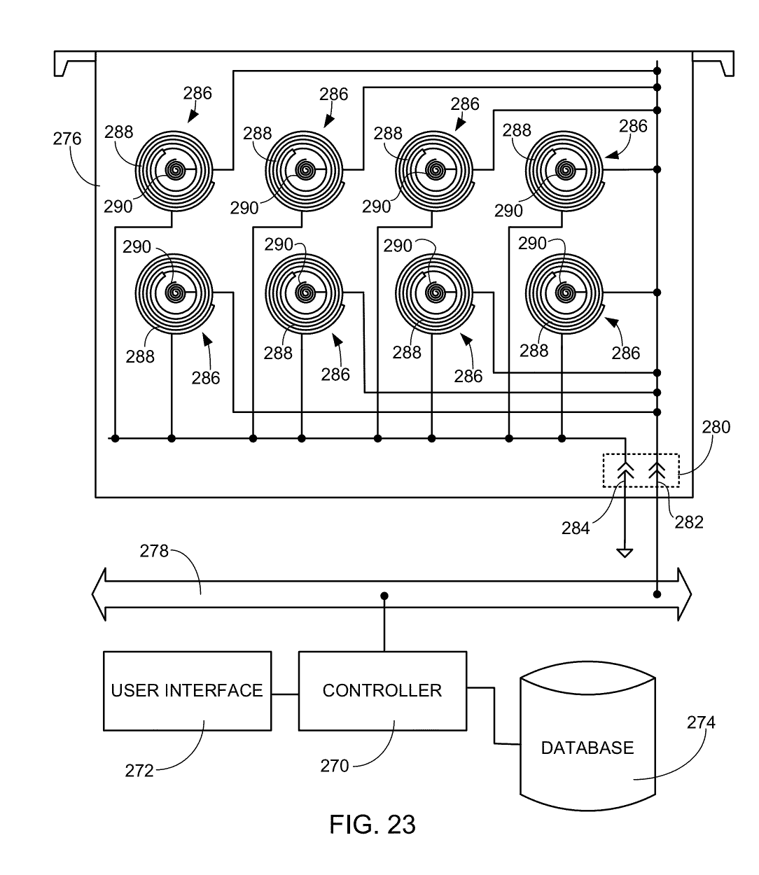

FIGS. 23-26 schematically illustrate different embodiments of an asset panel for use with a system for asset management. The system shown in FIG. 23 has a controller 270 coupled to a user interface 272 and a database 274 as has been discussed above. The controller 270 is also coupled to an asset panel 276 via a 1-wire communication bus 278. The 1-wire communication bus refers to the fact that only one signal wire is needed (in addition to a ground connection) for communication. A suitable 1-wire communication bus may be implemented using the Dallas Semiconductor 1-wire protocol developed for their touch memory iButton devices and is familiar to those skilled in the art.

A connector 280 may be provided on the asset panel 276 to have a 1-wire signal connection 282 and a ground connection 284. A plurality of memory button mounts 286 may be present on the asset panel 276, each memory button mount 286 having a gripping coil 288 and a contact coil 290. The contact coils 290 are all coupled to the 1-wire signal connection 282 by circuit traces and/or other conductive paths, such as, but not limited to wires. Similarly, the gripping coils 288 are all coupled to the ground connection 284 by circuit traces and/or other conductive paths, such as, but not limited to wires.

Using a 1-wire protocol, the controller 270 may query the asset panel 276 coupled to the 1-wire bus 278 to see what, if any, iButton identification tags are plugged into memory button mounts 286. If a memory button is present, it will respond to a query from the controller 270, letting the controller know the memory button (and therefore the asset associated with the memory button) is present. Depending on the embodiment, a greater or fewer number of memory button mounts may be present on an asset panel, and more than one asset panel could be coupled to the 1-wire communication bus 278 at the same time.

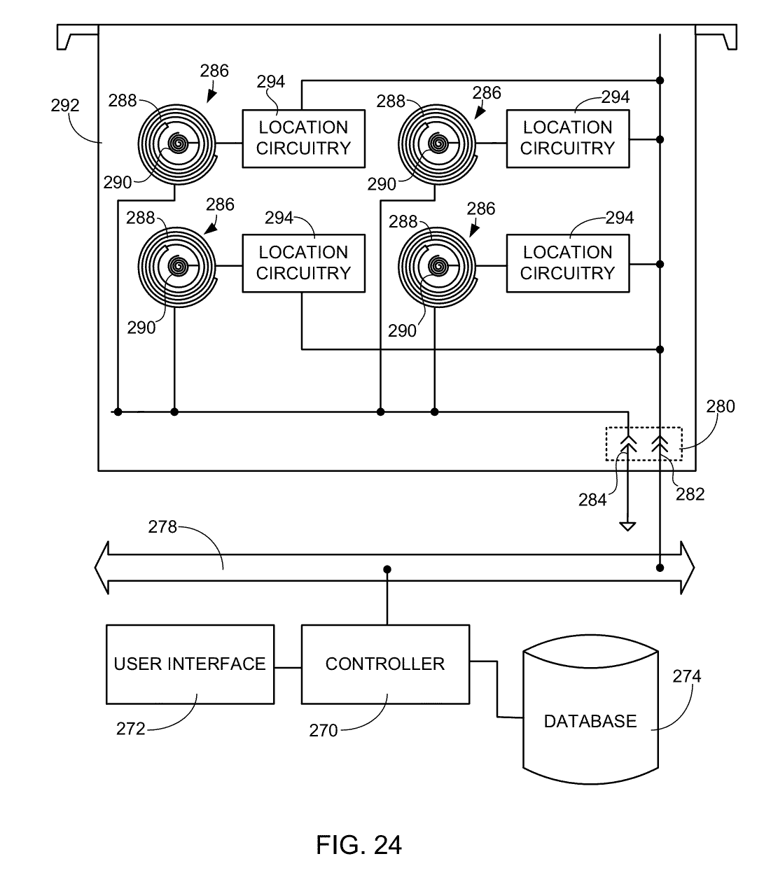

FIG. 24 schematically illustrates another embodiment of an asset panel for use with a system for asset management. The system shown in FIG. 24 has a controller 270 coupled to a user interface 272 and a database 274 as has been discussed above. The controller 270 is also coupled to an asset panel 292 via a 1-wire communication bus 278 in a manner as has been discussed previously. A connector 280 may be provided on the asset panel 292 to have a 1-wire signal connection 282 and a ground connection 284. A plurality of memory button mounts 286 may be present on the asset panel 292, each memory button mount 286 having a gripping coil 288 and a contact coil 290.

Location circuitry 294 may be provided for each memory button mount 286 in order to enable the controller 270 to know not only if a memory button is present, but in which specific memory button mount it is located. In this embodiment, location circuitry 294 is placed between the contact coil 290 of each memory button mount 286 and the 1-wire signal connection 282. The gripping coils 288 are all coupled to the ground connection 284 by circuit traces and/or other conductive paths, such as, but not limited to wires.

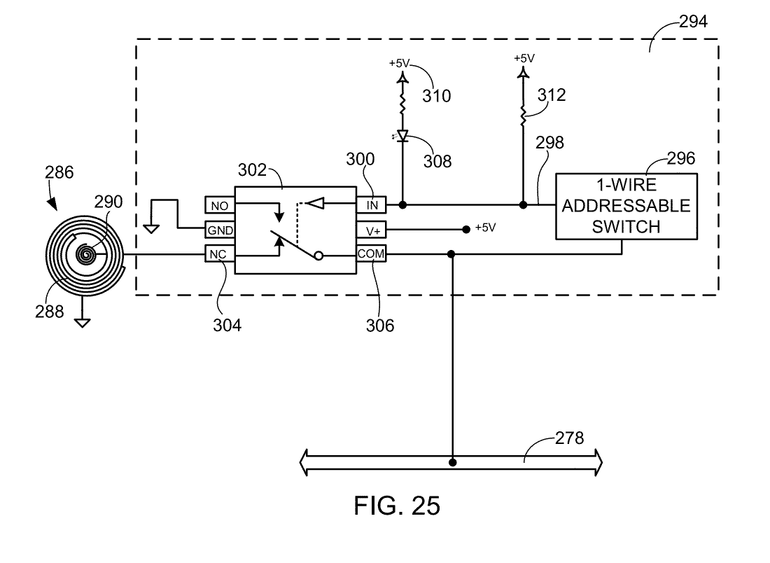

FIG. 25 illustrates one possible embodiment of location circuitry 294 suitable for use with a memory button mount 286. A 1-wire addressable switch 296 is coupled to the 1-wire bus 278. The 1-wire addressable switch 296 has a unique touch-memory-compatible identification that is known (programmatically or in a database) by the controller to be associated with the specific memory button mount 286 coupled to the location circuitry 294. One example of a suitable 1-wire addressable switch 296 is the 1-wire 8 Channel Addressable switch, model DS2408 from Maxim Integrated. The 1-wire addressable switch has at least one output line 298 which a controller (not shown in FIG. 25) coupled to the 1-wire bus 278 can set to a digital high voltage or a digital low voltage by properly addressing the 1-wire addressable switch 296 in a manner known to those skilled in the art. In this embodiment, the output line 298 is coupled to a digital control input 300 of an analog switch 302. One example of a suitable analog switch 302 is the Analog Switch Model TS5A3160 from Texas Instruments. In the embodiment of FIG. 25, the digital control input 300 enables the switch 302 when the control input 300 set to digital low, and disables it when set to digital high. The contact coil 290 of the memory button mount 286 is coupled to a normally closed pin 304 of the analog switch 302. A COM pin 306 of the analog switch 302 is coupled to the 1-wire bus 278.

In operation, when the controller (not shown) instructs the 1-wire addressable switch 296 to set the output line 298 to digital low, the analog switch 302 will be enabled, allowing the contact spring 290 to be coupled to the 1-wire bus 278 via the normally closed connection between pins 304 and 306 of the analog switch. When the controller instructs the 1-wire addressable switch 296 to set the output line 298 to digital high, the analog switch 302 will be disabled, preventing the contact spring 290 from being coupled to the 1-wire bus 278. An indicator, such as LED 308 may be coupled between a voltage source 310 and the digital control input 300. When the digital control input 300 is set low, enabling the connection of the contact spring 290 to the 1-wire bus 278 as described above, the LED 308 will be lit. Likewise, when the digital control input 300 is set high, disabling the connection between the contact spring 290 and the 1-wire bus 278 as described above, the LED will not be lit, since a pull-up resistor 312 ensures that current does not flow through the LED 308.

In a system, there can be multiple memory button mounts, each having their own location circuitry 294. The controller may be configured to periodically run an algorithm to take an inventory of the iButton addresses (for any iButtons installed in a memory button mount) and correlate them with the 1-Wire switch addresses. One non-limiting way to do this is to enable all of the 1-wire addressable switch output ports (set them to high), and then, 1-by-1, disable a single switchable output port (thereby enabling the associated possible iButton connection), and check to see if a new 1-wire device appears. If it does, then the appearing 1-wire device (attached to a key, for example) is mapped to the 1-wire addressable switch/output port which was disabled. This can then be repeated for all positions. Another non-limiting way to do this is to do the opposite by disabling all of the 1-wire addressable switch output ports (set them to low), and take an inventory of the available iButton devices (since all will be coupled to the 1-wire bus). Then, 1-by-1 enable a single switchable output port (thereby disabling the associated possible iButton connection) and check to see if a 1-wire device disappears from the list of all iButton devices. If it does, then the disappearing 1-wire device is mapped to the 1-wire addressable switch/output port which was enabled.

Being able to inventory the available iButton devices lets the system check to see if an authorized administrator or other user has removed or returned an asset. Furthermore, when each addressable switch is mapped to a known asset, the location circuitry can be used to locate the asset for a user. As one example, when an authorized user opens the file cabinet looking for a particular key, the key position can be highlighted by setting the associated 1-wire addressable switch output port low, thereby turning on the associated LED. This also couples the indicated iButton to the 1-wire bus so the controller can monitor for the moment of asset removal if desired. It is worth noting with such an embodiment that any iButtons in positions which are not lit (because the associated 1-wire addressable switch output port is set high) will not show up on the 1-wire bus during this time. Thus it is advisable for the controller to perform an inventory at the end of a transaction or period of time to check to see exactly what assets were removed by the user.

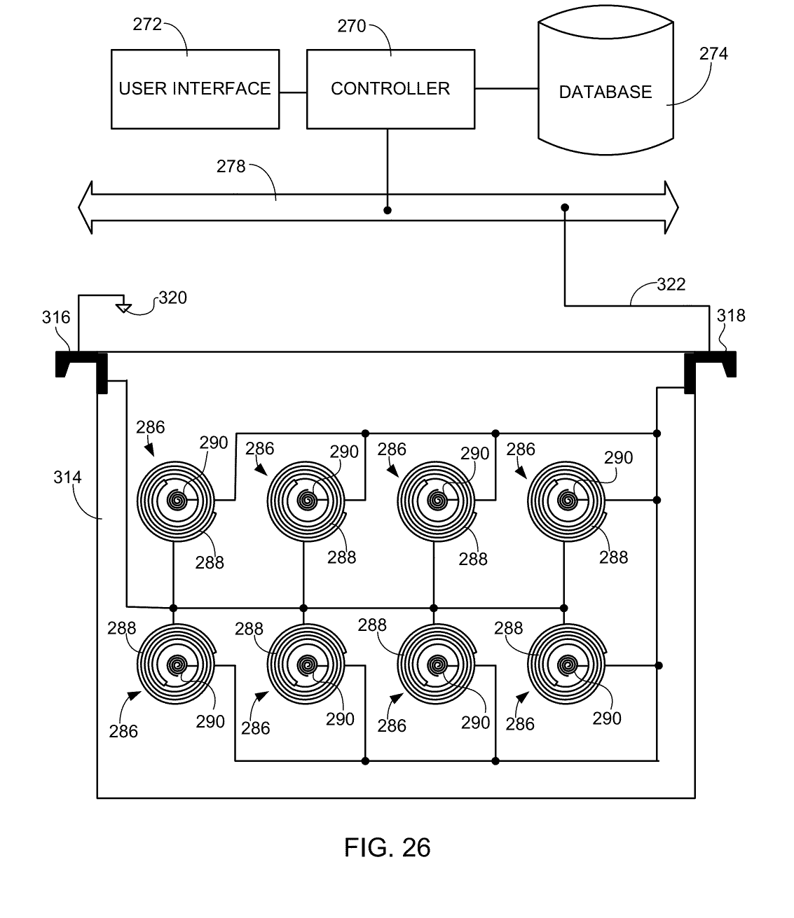

FIG. 26 schematically illustrates another embodiment of an asset panel 314 for use with a system for asset management. The system shown in FIG. 26 has a controller 270 coupled to a user interface 272 and a database 274 as has been discussed above. The controller 270 is also coupled to the asset panel 314 via a 1-wire communication bus 278. The features of the 1-wire communication bus 278 have been discussed previously. In this embodiment, rather than using a connector to couple to the 1-wire communication bus 278 as discussed with previous embodiments, two hanging hooks 316 and 318 (made from conductive material) are provided to couple a ground 320 and a 1-wire signal 322, respectively to the asset panel 314. The ground 320 can be coupled to one hanging file rail in a file drawer and the 1-wire signal 322 can be coupled to the other hanging file rail in the file drawer, provided the file rails are properly electrically isolated from each other as is known to those skilled in the art. In such an embodiment, the simple act of hanging the conductive hooks 316, 318 from the file rails will provide the necessary electrical connections to the asset panel. This can provide added convenience if it is desirable to remove the asset panels without having to disconnect a cable connector from the asset panel.

As with previous embodiments, a plurality of memory button mounts 286 may be present on the asset panel 314, each memory button mount 314 having a gripping coil 288 and a contact coil 290. The contact coils 290 are all coupled to the 1-wire signal connection 318 by circuit traces and/or other conductive paths, such as, but not limited to wires. Similarly, the gripping coils 288 are all coupled to the ground connection 316 by circuit traces and/or other conductive paths, such as, but not limited to wires.

Using a 1-wire protocol, the controller 270 may query the asset panel 314 coupled to the 1-wire bus 278 to see what, if any, iButton identification tags are plugged into memory button mounts 286. If a memory button is present, it will respond to a query from the controller 270, letting the controller know the asset associated with the memory button is present. Depending on the embodiment, a greater or fewer number of memory button mounts may be present on an asset panel, and more than one asset panel could be coupled to the 1-wire communication bus 278 at the same time. Furthermore, similar embodiments having location circuitry may be used as described above.

Having thus described several embodiments of the claimed invention, it will be rather apparent to those skilled in the art that the foregoing detailed disclosure is intended to be presented by way of example only, and is not limiting. Many advantages for the systems and methods for asset assignment have been discussed. Various alterations, improvements, and modifications will occur and are intended to those skilled in the art, though not expressly stated herein. These alterations, improvements, and modifications are intended to be suggested hereby, and are within the spirit and the scope of the claimed invention. Additionally, the recited order of the processing elements or sequences, or the use of numbers, letters, or other designations therefore, is not intended to limit the claimed processes to any order except as may be specified in the claims. Accordingly, the claimed invention is limited only by the following claims and equivalents thereto.

What is claimed is:

1. A method of asset assignment, comprising:
using a user interface, authenticating a first administrator;
using the user interface, authenticating a recipient;
using the user interface, identifying an asset;
assigning the identified asset to the authenticated recipient with an authority of the authenticated first administrator; and
storing a data record linking the assigned asset to the authenticated recipient.

2. The method of claim 1, wherein identifying the asset comprises scanning an identification tag coupled to the asset.

3. The method of claim 1, wherein identifying the asset comprises entering an identification code associated with the asset.

4. The method of claim 1, further comprising:
reauthenticating the recipient;
ascertaining the asset previously assigned to the recipient from the stored data record;
locating a duplicate asset of the previously assigned asset; and
assigning the duplicate asset to the reauthenticated recipient.

5. The method of claim 4, wherein locating the duplicate asset of the previously assigned asset comprises unlocking a replacement asset storage where the duplicate asset is stored.

6. The method of claim 4, wherein locating the duplicate asset of the previously assigned asset comprises activating at least one indicator showing a location of the duplicate asset.

7. The method of claim 1, wherein storing the data record linking the assigned asset to the authenticated recipient comprises also storing the authenticated first administrator as part of the data record.

8. The method of claim 1, further comprising:
temporarily assigning one or more assets to the authenticated first administrator, wherein identifying the asset comprises identifying the asset from the one or more assets temporarily assigned to the authenticated first administrator, and unassigning the identified asset from the authenticated first administrator.

9. The method of claim 8, further comprising:
returning a remaining number of assets from the one or more assets temporarily assigned to the authenticated first administrator to an initial asset storage; and
unassigning the returned assets from the authenticated first administrator.

10. The method of claim 9, further comprising:
auditing the returned remaining number of assets versus the temporarily assigned one or more assets and any assets assigned to one or more identified users and reporting any missing assets identified in the audit.

11. The method of claim 4, further comprising:
authenticating a second administrator, wherein assigning the duplicate asset to the reauthenticated recipient occurs with an authority of the authenticated second administrator.

12. The method of claim 11, wherein locating the duplicate asset of the previously assigned asset comprises unlocking a replacement asset storage where the duplicate asset is stored.

13. The method of claim 11, wherein locating the duplicate asset of the previously assigned asset comprises activating at least one indicator showing a location of the duplicate asset.

14. A system for asset assignment, comprising:
an asset panel including a pair of opposed electrically conductive supports extending from a top of the panel and a plurality of asset positions on a face of the panel, each position including an asset mount, a first contact coupled to a first of the supports, and a second contact coupled to a second of the supports, the first and second contacts being arranged to couple to respective contacts of an identification tag of an asset;
a file cabinet including at least one drawer, each drawer including a pair of electrically conductive opposed support rails, one of each pair of support rails being coupled to a source of electricity and the other of each pair of support rails being coupled to ground, the support rails being sized and arranged to removably support the asset panel by the asset panel supports such that a bottom of the panel is suspended above a bottom of the drawer and each support rail is in electrical contact with a respective panel support; and
a controller coupled to the user interface, the database, and each pair of electrically conductive support rails such that the controller couples with the asset panel when the asset panel is supported by the support rails, the controller thereby coupling with each pair of asset mount contacts such that the controller is in electrical communication with any identification tag in contact with a respective pair of asset mount contacts.

15. The system of claim 14, further comprising a database with which the controller is in communication, and wherein the controller includes instructions that when executed by the controller cause the controller to request a unique asset identifier from any identification tag in contact with a respective pair of contacts of the panel and to store a data record in the database corresponding to the unique asset identifier.

16. The system of claim 15, further comprising a user interface (UI) mounted on the file cabinet and coupled to the controller, wherein the instructions cause the controller to authenticate a recipient via the UI, to assign an asset to the authenticated recipient, and to link the authenticated recipient with the unique asset identifier in the data record.

17. The system of claim 16, wherein the UI comprises at least one input device selected form the group consisting of a keypad, a bar code scanner, a proximity card reader, a magnetic card reader, and a biometric device.

18. The system of claim 14, further comprising a replacement asset storage including another asset panel, the another asset panel including a duplicate asset of each asset on the panel.

19. The system of claim 14, further comprising at least one of a file cabinet indicator associated with the file cabinet and coupled and responsive to the controller, file drawer indicator associated with a respective one of the at least one file drawer and coupled and responsive to the controller, a panel indicator on the panel and coupled and responsive to the controller, and an asset indicator associated with each asset mount on the panel and coupled and responsive to the controller.

20. An asset assignment system comprising:
a file cabinet including at least one drawer, each drawer including a drawer indicator;
a pair of electrically conductive opposed support rails in each of the at least one drawer, one of each pair of support rails being coupled to a source of electricity and the other of each pair of support rails being coupled to ground;
at least one panel removably supported by a respective pair of opposed support rails, each panel including a pair of opposed electrically conductive supports extending from a top of the panel so as to hang the panel from the respective pair of support rails while placing each support in electrical communication with a respective support rail, each panel further including a plurality of asset positions sized and dimensioned to removably support a respective asset, each asset position being associated with a respective asset indicator mounted on the panel and in electrical communication with the supports; and
a controller including a computer processor and coupled to each drawer indicator, each pair of support rails, and to each asset indicator, as well as to a non-transitory computer readable storage medium that includes instructions in the form of computer executable code that when executed by the computer processor causes the controller to selectively activate a respective drawer indicator, panel indicator, and asset indicator to identify a location of a respective asset.

21. The asset assignment system of claim 20, further comprising a user interface (UI) coupled to the controller and a database coupled to the controller, wherein the instructions further cause the controller to:
authenticate a recipient via the UI;
identify an asset via the UI;
assign the identified asset to the authenticated user;
identify the location of the identified asset; and
store a data record linking the identified asset and the authenticated user.

22. The asset assignment system of claim 21, wherein the instructions further cause the controller to:
reauthenticate the recipient;
ascertain the asset previously assigned to the recipient from the stored data record;
locate a duplicate asset of the previously assigned asset;
assign the duplicate asset to the reauthenticated recipient; and
activate the respective drawer indicator, panel indicator, and asset indicator of the duplicate asset.

23. The asset assignment system of claim 22, wherein the instructions further cause the controller to:
authenticate a first administrator;
temporarily assign one or more assets to the authenticated first administrator, wherein the identified asset is part of the one or more assets;
unassign the identified asset from the authenticated first administrator;
unassign a remaining number of assets from the one or more assets from the authenticated first administrator when the remaining number of assets is returned to respective asset positions in the file cabinet;
audit the returned remaining number of assets versus the temporarily assigned one or more assets;
identify any missing asset; and
report any identified missing asset.
